(19) United States
(12) Patent Application Publication
(10) Pub. No.: US 2007/0207435 A1
(43) Pub. Date: Sep. 6, 2007

(54) Orthodontic appliance and method of debonding same

(76) Inventor: Thirumal N. Devanathan, Westville, IN (US)

Correspondence Address: MICHAEL A. O'NEIL, P.C., 5949 SHERRY LANE, SUITE 820, DALLAS, TX, 75225, US

(21) Appl. No.: 11/368,724

(22) Filed: Mar. 6, 2006

(51) Int. Cl. A61C 3/00

(52) U.S. Cl. 433/9; 433/24; 433/4

(57) ABSTRACT

An orthodontic appliance and method of debonding comprises providing a ceramic orthodontic bracket having an undersurface, securing a rigid epoxy layer having a minimum thickness of 0.010 inches and having a tooth engaging undersurface to the undersurface of the ceramic orthodontic bracket, adhesively securing the tooth engaging surface of the epoxy layer to a tooth, thereafter applying orthodontic forces to the ceramic orthodontic bracket, and thereafter crushing the epoxy layer to debond the orthodontic bracket from the tooth.

### TECHNICAL FIELD

This invention relates generally to the field of orthodontia, and more particularly to an orthodontic appliance adapted for efficient and non-injurious debonding.

### BACKGROUND AND SUMMARY OF THE INVENTION

FIGS. 1 and 2 illustrate a ceramic orthodontic bracket of the type disclosed and claimed in U.S. Pat. No. 4,216,583 granted to James M. Reynolds on Aug. 12, 1980. The bracket 10 is generally recognized by orthodontists and by manufacturers of orthodontic appliances as the first commercially successful ceramic orthodontic bracket.

One characteristic of ceramic orthodontic brackets is that they are typically bonded directly to a tooth surface as opposed to being welded to a tooth encircling band as was the case with prior stainless steel orthodontic brackets. Because the forces that are imposed on teeth during orthodontia are substantial the strength of the adhesive bond between a ceramic orthodontic bracket and the surface of the tooth to which it is secured must be very substantial. As is well understood by those skilled in the art, the very tight adhesion between a ceramic orthodontic bracket and the underlying tooth surface that is necessary for orthodontia inhibits removal, i.e., debonding, of the ceramic bracket from the tooth when the orthodontic procedure has been completed.

Referring specifically to FIG. 2, the ceramic orthodontic bracket 10 is shown secured to the surface 12 of a tooth 14 as would be the case at the conclusion of an orthodontic procedure. The traditional method of debonding the bracket 10 from the surface 12 of the tooth 14 has been to interpose the jaws 16 of a pair of debonding pliers between the tooth surface 12 and the bottom surface of the ceramic orthodontic bracket 10. This procedure is problematic because the tooth surface 12 is relatively soft and fragile as compared with the hard, tough material utilized in the manufacture of ceramic brackets and the tool grade stainless steel that is used in the manufacture of debonding pliers. As will therefore be understood, the orthodontic profession has sought a noninjurious method of debonding ceramic brackets from tooth surfaces ever since the introduction of ceramic brackets to the practice of orthodontia.

FIG. 3 illustrates a procedure for debonding ceramic orthodontic brackets of the type disclosed and claimed in U.S. Pat. No. 4,907,965 granted to Patrick E. Martin on Mar. 13, 1990. The debonding technique of the '965 patent employs a heating device 20 to weaken the bond between a ceramic bracket 22 and the surface 24 of a tooth 26. After the bond between the ceramic bracket 22 and the tooth surface 24 has been sufficiently weakened a puller device 28 is employed to complete the debonding of the bracket 22. On information and behalf the debonding device of the '965 patent was not commercially successful and is no longer manufactured.

FIG. 4 illustrates an orthodontic appliance mounting and debonding technique of the type disclosed and claimed in U.S. Pat. No. 5,098,288 granted to Peter C. Kesling on Mar. 24, 1992. In accordance of the technique of the '288 patent a flexible bonding pad 30 is adhesively secured to the surface 32 of a tooth 34. A ceramic bracket 36 is in turn adhesively secured to the flexible bonding pad 30. At the conclusion of the orthodontic procedure the jaws 38 of a pair of debonding pliers are employed to buckle the flexible bonding pad 30 thereby simultaneously disengaging both the flexible bonding pad 30 and the ceramic bracket 38 from the tooth surface 34. On information and belief the debonding technique of the '288 patent was not commercially successful and the component parts thereof as shown in FIG. 4 are no longer manufactured.

The present invention comprises a ceramic orthodontic bracket construction and a method of debonding ceramic orthodontic brackets which overcomes the foregoing and other difficulties which have long since characterized the prior art. In accordance with the broader aspects of the invention an otherwise conventional ceramic bracket has a layer of rigid epoxy secured to the undersurface thereof. The epoxy layer has a minimum thickness of 0.010 inches. The orthodontic bracket is secured to the surface of the tooth by bonding the undersurface of the epoxy layer to the tooth surface utilizing conventional orthodontic bonding techniques. At the conclusion of the orthodontic procedure, the jaws of a pair of conventional orthodontic debonding pliers are applied against the opposite sides of the rigid epoxy layer whereby the epoxy layer to caused to shatter thereby releasing the ceramic orthodontic appliance from the tooth surface. Any remnants of the epoxy layer which remain adhered to the tooth surface are easily removed utilizing conventional dental cleaning techniques.

### BRIEF DESCRIPTION OF THE DRAWINGS

A more complete understanding of the present invention may be had by reference to the following Detailed Description when taken in connection with the accompanying Drawings, wherein:

FIG. 1 is a perspective view of the Orthodontic Appliance disclosed and claimed in U.S. Pat. No. 4,216,583 granted to James M. Reynolds on Aug. 12, 1980;

FIG. 2 is a top view of the Orthodontic Appliance of FIG. 1 showing the Appliance secured to the surface of a tooth;

FIG. 3 is a sectional view illustrating the Electrothermal Dental Debracketing Tool and Method of Removal disclosed and claimed in U.S. Pat. No. 4,907,965 granted to Patrick E. Martin on Mar. 13, 1990;

FIG. 4 is an illustration of the Flexible Bonding Pad for an Orthodontic Bracket disclosed and claimed in U.S. Pat. No. 5,098,288 granted to Peter E. Kesling on Mar. 24, 1992;

FIG. 5 is an illustration of the ceramic bracket of the present invention showing the bracket bonded to the surface of a tooth;

FIG. 6 is an illustration of an early step in the method of debonding ceramic brackets comprising the present invention; and

FIG. 7 is an illustration of a later step in the method of debonding ceramic brackets comprising the present invention.

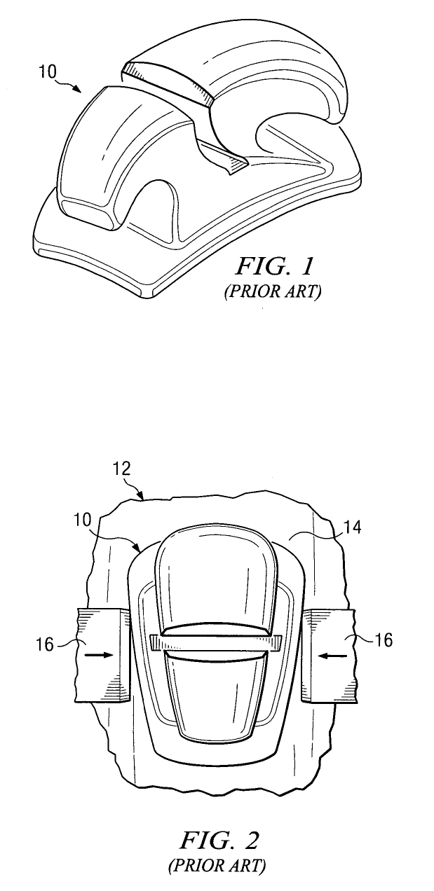

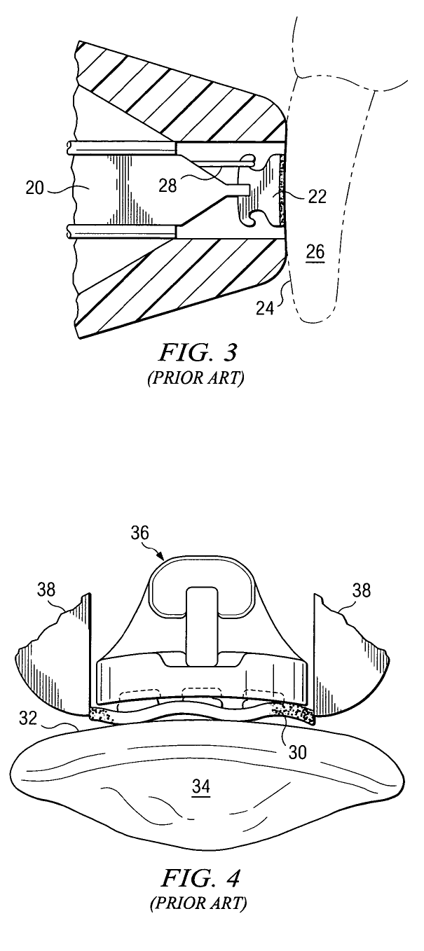

### DETAILED DESCRIPTION

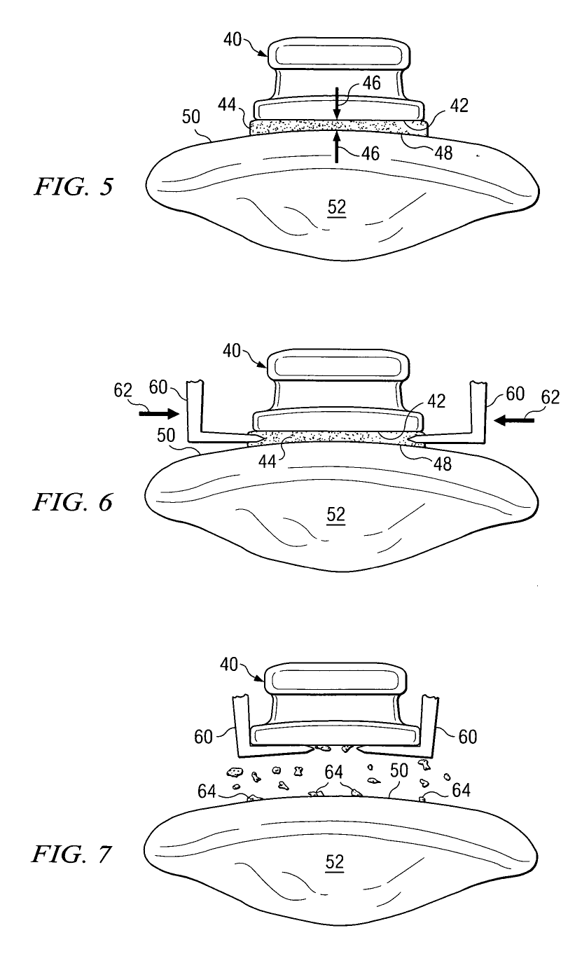

Referring now to the drawings, and particularly to FIG. 5 thereof, there is shown an otherwise conventional ceramic bracket 40 having an undersurface 42. FIG. 5 illustrates the undersurface 42 as comprising a planar surface; however, those skilled in the art will understand that the undersurface 42 can comprise other surface configurations.

A layer 44 comprising rigid epoxy or equivalent is adhesively secured to the undersurface 42 of the bracket 40. The layer of rigid epoxy 44 may be applied to the undersurface 42 of the bracket 40 in liquid form in which case the layer of epoxy 44 self-adheres to the material comprising the bracket 40. Alternatively, the layer of rigid epoxy 44 may be secured to the undersurface 42 of the bracket 44 in solid form in which case an adhesive of the type commonly used in the practice of orthodontia is utilized to secure the layer of epoxy 44 to the undersurface 42 of the bracket 40.

Regardless of whether it is applied in liquid or solid form, the layer of epoxy 44 has a minimum thickness as represented by the arrows 46, it being understood that the arrows 46 do not necessarily designate the precise location of the minimum thickness of the layer of epoxy 44. The present invention comprises in part the discovery that the minimum thickness of the layer of epoxy 44 as represented by the arrows 46 must be at least 0.010 inches in order that the debonding method of the present invention can be successfully accomplished. In this regard, it is noted that layers of epoxy of various thicknesses have theretofore been applied to the undersurfaces of ceramic orthodontic brackets. However, it has not heretofore been realized that a minimum thickness of 0.010 inches of the layer of epoxy is critical in order to successfully accomplish the ceramic orthodontic bracket debonding method of the present invention.

The epoxy layer 44 has a tooth engaging undersurface 48 which may have a spherical configuration or any other surface configuration in accordance with particular applications of the invention. Regardless of how the epoxy layer 44 is secured to the undersurface 42 of the bracket 40 the undersurface 48 of the layer 44 is adhesively secured to the surface 50 of a tooth 52 utilizing conventional techniques for bonding orthodontic brackets to tooth surfaces. Thereafter conventional orthodontic techniques are utilized to straighten the tooth 52 by means of the bracket 40. Eventually the orthodontic procedure is completed at which time it is necessary to debond the bracket 40 from the tooth 52.

In accordance with the method of debonding orthodontic brackets of the present invention, the jaws 60 of a pair of orthodontic debonding pliers (represented diagrammatically in FIG. 6) are forced inwardly as indicated by the arrows 62. As the jaws 60 are forced inwardly, the rigid epoxy layer 44 is crushed or shattered thereby separating the ceramic orthodontic bracket 40 from the tooth 52. The jaws 60 of the orthodontic debonding pliers are then utilized to remove the bracket 40 in the manner illustrated in FIG. 7. Other conventional techniques for removing debonded orthodontic brackets may also be employed in the practice of the invention. Any particles 64 comprising remnants of the epoxy layer 44 are easily removed from the surface 50 of the tooth 52 utilizing conventional dental cleaning techniques including both well known grinding devices and well known polishing devices. Thus, in accordance with the method of the present invention the surface 50 of the tooth 52 is rendered free of debris and undamaged at the completion of the orthodontic procedure.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. An orthodontic appliance comprising:
a ceramic orthodontic bracket having an undersurface;
a rigid epoxy layer having a tooth engaging undersurface;
means for securing the epoxy layer to the undersurface of the ceramic orthodontic bracket;
the epoxy layer having a minimum thickness of at least 0.010 inches.

2. The orthodontic appliance according to claim 1 wherein the undersurface of the ceramic orthodontic bracket is planar.

3. The orthodontic appliance according to claim 1 wherein the tooth engaging undersurface of the epoxy layer is curvilinear.

4. The orthodontic appliance according to claim 1 wherein the undersurface of the ceramic orthodontic bracket is planar and wherein the tooth engaging undersurface of the epoxy layer is curvilinear.

5. The orthodontic appliance according to claim 1 wherein the means for securing the epoxy layer to the undersurface of the ceramic orthodontic bracket comprises an initially liquid epoxy layer engaged with the undersurface of the ceramic orthodontic bracket.

6. The orthodontic appliance according to claim 1 wherein the means for securing the epoxy layer to the undersurface of the ceramic orthodontic bracket comprises an adhesive layer positioned between the undersurface of the orthodontic bracket and the epoxy layer.

7. A method of manufacturing an orthodontic appliance comprising the steps of:
providing a ceramic orthodontic bracket having an undersurface;
providing a rigid epoxy layer having a tooth engaging undersurface and having a minimum thickness of at least 0.010 inches; and
securing the epoxy layer to the undersurface of the orthodontic bracket.

8. The method of manufacturing an orthodontic appliance according to claim 7 wherein the step of providing an orthodontic bracket having an undersurface is characterized by providing an orthodontic bracket having a planar undersurface.

9. The method of manufacturing an orthodontic appliance according to claim 7 wherein the step of providing an epoxy layer is further characterized by providing an epoxy layer having a curvilinear tooth engaging undersurface.

10. The method of manufacturing an orthodontic appliance according to claim 7 wherein the step of providing an orthodontic bracket having an undersurface is characterized by providing an orthodontic bracket having a planar undersurface and wherein the step of providing an epoxy layer is characterized by providing an epoxy layer having a curvilinear undersurface.

11. The method of manufacturing an orthodontic appliance according to claim 7 wherein the step of securing the epoxy layer to the undersurface of the ceramic orthodontic bracket is carried out by engaging the undersurface of the ceramic orthodontic bracket is carried out by forming an initially liquid epoxy layer.

12. The method of manufacturing an orthodontic appliance according to claim 7 wherein the step of securing an epoxy layer to the undersurface of the ceramic orthodontic bracket is carried out by providing a solid epoxy layer and adhesively securing the solid epoxy layer to the undersurface of the ceramic orthodontic bracket.

13. A method of orthodontia comprising the steps of:
providing an orthodontic bracket having an undersurface;
providing a rigid epoxy layer having a minimum thickness of 0.010 inches and having a tooth engaging undersurface;
securing the epoxy layer to the undersurface of the ceramic orthodontic bracket;
thereafter securing the tooth engaging undersurface of the epoxy layer in engagement with a tooth of a human being;
thereafter applying orthodontic forces to the ceramic orthodontic bracket and thereby cause movement of the tooth; and
thereafter crushing the epoxy layer and thereby disengaging the orthodontic bracket from the tooth.

14. The method of orthodontia according to claim 13 wherein the step of providing an orthodontic bracket having an undersurface is characterized by providing an orthodontic bracket having a planar undersurface.

15. The method of orthodontia according to claim 13 wherein the step of providing an epoxy layer is further characterized by providing an epoxy layer having a curvilinear tooth engaging undersurface.

16. The method of orthodontia according to claim 13 wherein the step of providing an orthodontic bracket having an undersurface is characterized by providing an orthodontic bracket having a planar undersurface and wherein the step of providing an epoxy layer is characterized by providing an epoxy layer having a curvilinear undersurface.

17. The method of orthodontia according to claim 13 wherein the step of securing the epoxy layer to the undersurface of the ceramic orthodontic bracket is carried out by engaging the undersurface of the ceramic orthodontic bracket is carried out by forming an initially liquid epoxy layer.

18. The method of orthodontia according to claim 13 wherein the step of securing an epoxy layer to the undersurface of the ceramic orthodontic bracket is carried out by providing a solid epoxy layer and adhesively securing the solid epoxy layer to the undersurface of the ceramic orthodontic bracket.

19. The method of orthodontia according to claim 13 wherein the step of securing the tooth engaging undersurface of the epoxy layer in engagement with a tooth of a human being is carried out by adhesively bonding the tooth engaging undersurface of the epoxy layer to the surface of the tooth.

20. The method of orthodontia according to claim 13 including the subsequent step of removing remnants of the epoxy layer from the tooth following the step of crushing the epoxy layer.
